(19) United States
(12) Patent Application Publication
(10) Pub. No.: US 2025/0362813 A1
(43) Pub. Date: Nov. 27, 2025

(54) METHOD AND SYSTEM FOR WRITING DATA IN POWER SUPPORT COMPONENT FAILURE MODE

(71) Applicant: SAMSUNG ELECTRONICS CO., LTD., Suwon-si (KR)

(72) Inventors: Anantha SHARMA, Bangalore (IN); Nishchay MALAKAR, Bangalore (IN); Sushma VISHWAKARMA, Bangalore (IN); Gangeyamoorthy AYYANAR PONNUSAMY, Bangalore (IN); Pavan PADKI, Bangalore (IN); Sharath Kumar KODASE, Bangalore (IN)

(73) Assignee: SAMSUNG ELECTRONICS CO., LTD., Suwon-si (KR)

(21) Appl. No.: 18/999,853

(22) Filed: Dec. 23, 2024

(30) Foreign Application Priority Data
May 24, 2024 (IN) 202441040494
Jun. 13, 2024 (IN) 202441040494

(51) Int. Cl. G06F 3/06

(52) U.S. Cl. CPC G06F 3/0619; G06F 3/0616; G06F 3/064; G06F 3/0679

(57) ABSTRACT

A method performed by a data storage device, includes: receiving, by a controller of the data storage device, a data from a host device; detecting, by the controller of the data storage device, a failure in a power support component of the data storage device; creating, by the controller, a block of single level cells (SLC) comprising one or more groups of memory cells from one or more blocks of multi-level cells, in a persistent memory of the data storage device, based on values of predefined data storage parameters; and storing, by the controller, the data in the block of SLC.

### CROSS-REFERENCE TO RELATED APPLICATIONS

This application is based on and claims priority under 35 U.S.C. § 119 to Indian Provisional Patent Application No. 202441040494, filed on May 24, 2024, and Indian Patent Application number 202441040494, filed on Aug. 13, 2024, in the Indian Intellectual Property Office, the disclosures of which are incorporated by references herein in their entireties.

### BACKGROUND

### 1. Field

The disclosure generally relates to data storage devices. More particularly, the disclosure relates to a method and a system for writing data in power support component failure mode.

### 2. Description of Related Art

Data storage devices store data and instructions to be processed in a computer system. These data storage devices may include a solid-state drive (SSD), a hard disk drive (HDD), and the like. A data storage device includes two types of memory such as a non-persistent memory and a persistent memory. The non-persistent memory is a temporary memory storage where the data is erased when a power supply to the data storage device is turned off. The persistent memory is a permanent memory storage where the data is retained even when the power supply to the data storage device is turned off.

Referring to FIG. 1, a storage device comprises a non-persistent memory 104 and a persistent memory 106. Generally, the non-persistent memory 104 receives data to be stored in the data storage device from a host device 102. Upon the non-persistent memory 104 receiving the data from the host device 102, the data is sent to a block of multi-level cells in the persistent memory 106 for permanently storing the data in the data storage device. The blocks of multi-level cells are processed upon filling all memory cells in groups of memory cells (WL 0, WL 1, . . . , WL N) with the data. Hence, wastage of storage capacity of the persistent memory 106 and performance degradation can be avoided. Thus, in a normal mode when the power is supplied to the data storage device on receiving the data equivalent to a total bit capacity of the groups of memory cells (WL 0, WL 1, . . . , WL N), the non-persistent memory 104 transfers the data to the persistent memory 106 cells in a single step for programming the multi-level cells. The total bit capacity refers to a total number of data bits that can be occupied by each of the groups of memory cells (WL 0, WL 1, . . . , WL N). For instance, the capacity of the multi-level cells may be 96 k bits, then, upon the non-persistent memory 104 receiving data of 96k bits from the host device 102, the data is transferred to the persistent memory 106 for storing.

In some cases when the power supply to the data storage device is turned off, a power support component such as capacitor may supply power to the data storage device for storing data to the persistent memory 106 for achieving data reliability. Further, in case, if the power support component fails, the data storage device enters Forced Unit Access (FUA) mode for archiving the data reliability as shown in FIG. 2.

In the FUA mode, upon a non-persistent memory 204 receiving data from a host device 202, the non-persistent memory 204 sends data to a persistent memory 206 without waiting for receiving the data equivalent to a total bit capacity of the groups of memory cells (WL 0, WL 1, . . . , WL N). Thus, in the FUA mode, in case a smaller number of data bits are received compared to the total bit capacity of the groups of memory cells (WL 0, WL 1, . . . , WL N) from the host device 202, the non-persistent memory 204 sends the same to the groups of memory cells (WL 0, WL 1, . . . , WL N) in the persistent memory 206 and rest of the memory cells in the groups of memory cells are filled with dummy data. For instance, consider that the capacity of each of the group of memory cells may be 96 k. In case, only 4 k of the data is received from the host device 202 as shown in the group of memory cells MLC WL 1, the non-persistent memory 204 transfers the 4 k data to the persistent memory 206 and the rest 92 k of capacity of memory cells may be filled with dummy data for processing the group of memory cells MLC WL 1. Hence, in the FUA mode, the non-persistent memory 204 may not wait for the data equivalent to the total bit capacity of the groups of memory cells (WL 0, WL 1, . . . , WL N). Thus, in the FUA mode while processing the multi-level cells, along with the memory cells filled with the data, the memory cells with the dummy data are also processed. Hence, for processing number of data bits which is not equivalent to the total capacity of the groups of memory cells, amount of time required is same as is required for processing the data equivalent to the total bit capacity of the groups of memory cells (WL 0, WL 1, . . . , WL N), as the dummy data in the memory cells are also processed along with the data. This leads to performance degradation of the data storage device and requires more time for processing the number of data bits which is comparatively less than the total capacity of the groups of memory cells. Further, the dummy data filled along with the data received from the host device 202 may result in wastage of storage capacity of the memory cells in the persistent memory 206.

### SUMMARY

According to an aspect of the disclosure, a method performed by a data storage device, includes: receiving, by a controller of the data storage device, a data from a host device; detecting, by the controller of the data storage device, a failure in a power support component of the data storage device; creating, by the controller, a block of single level cells (SLC) comprising one or more groups of memory cells from one or more blocks of multi-level cells, in a persistent memory of the data storage device, based on values of predefined data storage parameters; and storing, by the controller, the data in the block of SLC.

According to an aspect of the disclosure, a data storage device includes: a persistent memory; a non-persistent memory; and a controller configured to: receive a data from a host device, detect a failure in a power support component of the data storage device, create a block of Single Level Cells (SLC) comprising one or more group of memory cells from one or more blocks of multi-level cells, in the persistent memory of the data storage device, based on values of predefined data storage parameters, and store the data in the block of SLC.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other objects and features of the disclosure will become apparent by describing in detail embodiments thereof with reference to the accompanying drawings.

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 shows an existing illustration (related art) for storing data in a power supply mode;

FIG. 2 shows an existing illustration for storing data in a power support component failure mode;

FIG. 3 illustrates an environment for writing data in power support component failure mode, in accordance with one or more example embodiments of the disclosure;

FIG. 4 illustrates a detailed diagram of a data storage device for writing data in power support component failure mode, in accordance with one or more example embodiments of the disclosure;

FIG. 5A-5C show exemplary illustrations for writing data in power support component failure mode, in accordance with some embodiments of the disclosure;

FIG. 6 shows a flow chart illustrating method operations for writing data in power support component failure mode, in accordance with one or more example embodiments of the disclosure; and

FIG. 7 shows a block diagram of a computing system for writing data in power support component failure mode, in accordance with one or more example embodiments of the disclosure.

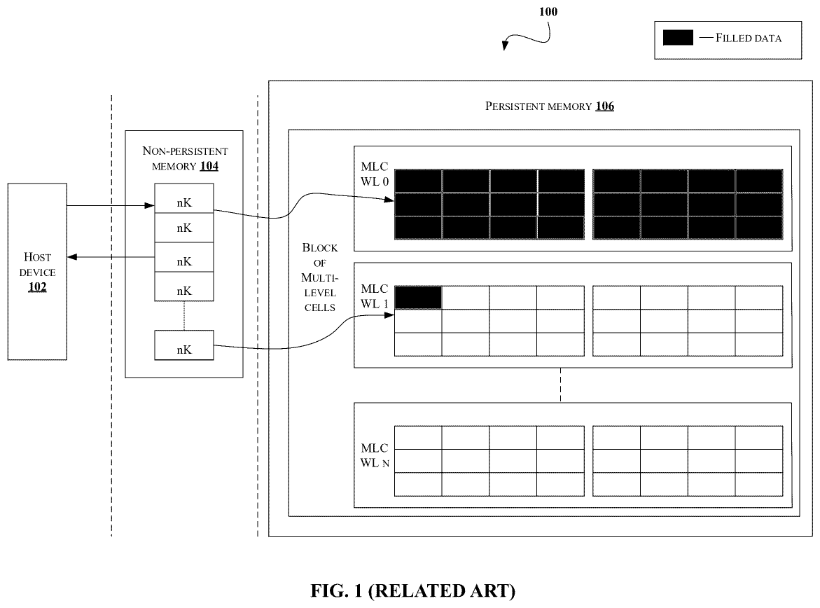

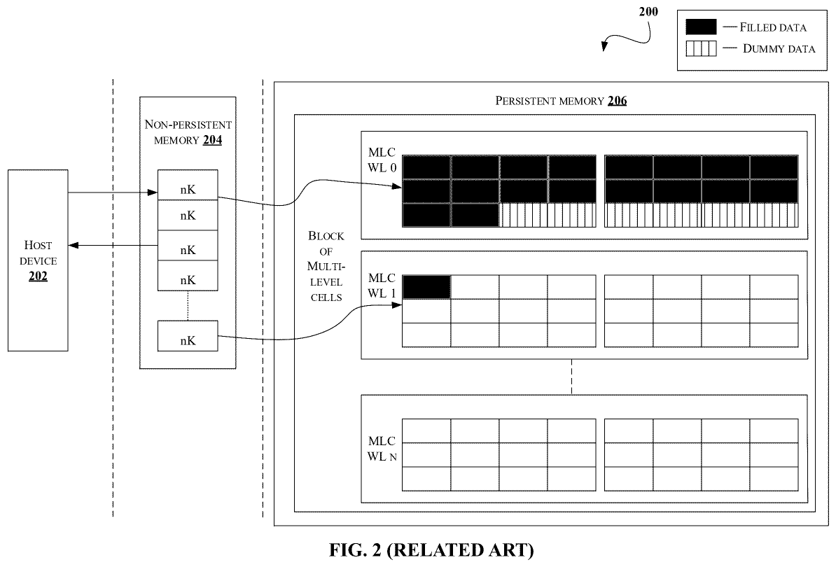

Those skilled in the art would understand that any block diagram herein represents conceptual views of illustrative systems embodying the principles of the inventive concepts of the disclosure. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

The terms “an example embodiment”, “embodiment”, “embodiments”, “the embodiment”, “the embodiments”, “one or more embodiments”, “some embodiments”, and “one embodiment” mean “one or more (but not all) embodiments of the disclosure” unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an example embodiment with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

In the disclosure, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or operations does not include only those components or operations but may include other components or operations not expressly listed or inherent to such setup or device or method. In other words, one or more elements in a system or apparatus proceeded by “comprises . . . a” does not, without more constraints, preclude the existence of other elements or additional elements in the system or apparatus.

The term “couple” and the derivatives thereof refer to any direct or indirect communication between two or more elements, whether or not those elements are in physical contact with each other. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

In the related art, in power support component failure mode, a non-persistent memory enters FUA mode for storing data in a persistent memory of the data storage device. In the FUA mode, along with data received from a host device, dummy data may also be filled in the persistent memory for processing the groups of memory cells in the persistent memory. Hence, for processing a number of data bits which is not equivalent to a total capacity of the groups of memory cells, amount of time required is same as the time required for processing the data equivalent to the total bit capacity of the groups of memory cells, due to the fact that dummy data in the memory cells are also processed along with the data received from the host device. This leads to performance degradation of the data storage device and requires more time for processing the number of data bits which is comparatively less than the total capacity of the groups of memory cells. Further, the dummy data filled along with the data received from the host device may result in wastage of storage capacity of the memory cells in the persistent memory.

According to an example embodiment, there is provided a method and a data storage device for writing data in power support component failure mode. When a failure in a power support component of the data storage device is detected, the data storage device creates a block of Single Level Cells (SLC) for storing the data received from a host device to the persistent memory of the storage device. According to an example embodiment of the disclosure, the data storage device creates the block of SLC from blocks of multi-level cells present in the persistent memory. The block of SLC includes groups of memory cells, where each group of memory cells includes multiple memory cells. Upon creation of the block of SLC, the data received from the host device is stored in the block of SLC. Thus, as the block of SLC occupies one bit in each memory cell, a non-persistent memory of the data storage device may transfer the received number of data bits to the persistent memory. In the persistent memory, as total data storage capacity of the block of SLC is low, number of dummy data to be filled in the block of SLC of the persistent memory is reduced. Hence, in the disclosure, wastage of storage capacity of the persistent memory can be avoided along with improving performance degradation of the data storage device.

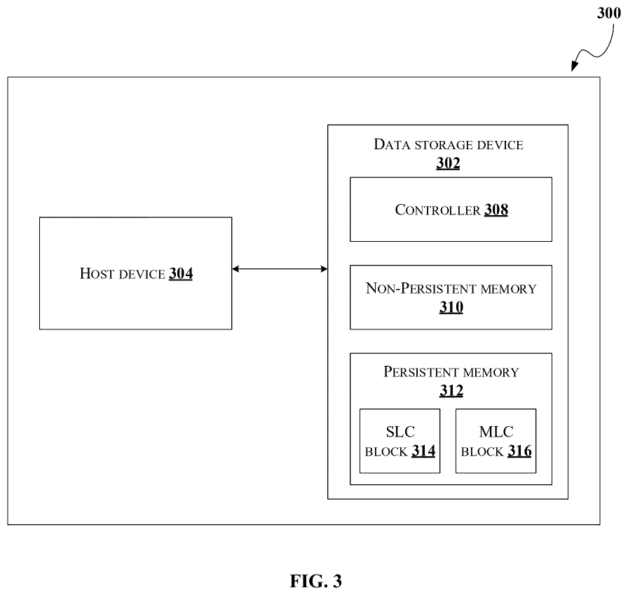

FIG. 3 illustrates an environment 300 for writing data in power support component failure mode according to one or more example embodiments. The environment 300 includes a data storage device 302 and a host device 304. The data storage device 302 stores data and/or instructions received from the host device 304. The data storage device 302 includes a solid-state drive (SSD), a hard disk drive (HDD), and the like. However, the disclosure is not limited thereto, and as such, according to another example embodiment, other types of storage device may be provided. The SSD is a solid-state device that uses integrated circuit assemblies to store data persistently, typically using flash memory, and functions as secondary storage in a hierarchy of computer storage. The HDD is an electro-mechanical data storage device that stores and retrieves digital data using magnetic storage. The host device 304 may be any computing device that communicates with the data storage device 302 on a network. The host device 304 may include, but is not limited to, a laptop computer, a desktop computer, a personal computer (PC), a notebook, a smartphone, a tablet, a server, and the like.

The data storage device 302 may include a controller 308, a non-persistent memory 310, and a persistent memory 312. The persistent memory 312 includes a block of Single Level Cells (SLC) 314 and blocks of multi-level cells 316. The block of SLC 314 may refer to a version of single-level cell memory capable of storing a single bit of information per memory cell. The block of Multi-Level Cells (MLC) may refer to a version of multi-level cell memory capable of storing multiple bits of information per memory cell.

For instance, the MLC may include, but is not limited to, triple-level cells capable of storing three bits of information per memory cell, Quad-level cells capable of storing four bits of information per memory cell, Penta-level cell capable of storing five bits of information per memory cell, and the like. In an embodiment, the controller 308 may be an electronic component of the data storage device 302 that acts as a bridge between the host device 304, the non-persistent memory 310 and the persistent memory 312. The controller 308 may be an embedded processor that executes failure detection, creation of the blocks of SLC 314 and storing data to the blocks of SLC. However, the disclosure is not limited thereto, and as such, according to another example embodiment, the controller 308 may be configured to perform other operations. The data storage device 302 stores the data of the host device 304. In an implementation, the non-persistent memory 310 may include a volatile memory such as Dynamic Random Access Memory (DRAM) and the persistent memory may include a non-volatile memory such as NAND flash memory. In yet another implementation, the data storage device 302 may include the non-persistent memory 310 as a cache. However, the disclosure is not limited thereto, and as such, according to another example embodiment, any other memory types may be used in the data storage device 302.

The host device 304 and the data storage device 302 may be connected via an interface. The interface may include an internal interface or an external interface. The interface may be implemented by using various interface schemes, but not limited to, an Advanced Technology Attachment (ATA), Serial ATA (SATA), external SATA (e-SATA), Small Computer Small Interface (SCSI), Serial Attached SCSI (SAS), Peripheral Component Interconnection (PCI), PCI express (PCIe), NVMe, IEEE 1394, a Universal Serial Bus (USB) interface, a Secure Digital (SD) card interface, a Multi-Media Card (MMC) interface, an eMMC interface, a Universal Flash Storage (UFS) interface, an embedded UFS (eUFS) interface, and a Compact Flash (CF) card interface.

The controller 308 may be configured to store data in the data storage device 302 during a failure in a power support component of the data storage device 302. According to an example embodiment, the controller 308 may detect a failure in the power support component of the data storage device 302 while storing the data received from the host device 304 to the data storage device 302. The power support component may refer to components such as a capacitor that supplies power to the data storage device 302 for storing the data in the persistent memory 312 of the data storage device 302 while in the power failure state. The controller 308 may detect the failure in the power support component using known techniques and hardware components such as, register, interrupter, and the like.

Further, the controller 308 may create a block of SLC 314 including one or more group of memory cells from one or more blocks of the MLC 316, in the persistent memory 312 of the data storage device 302. In an embodiment, the block of SLC 314 may be created based on values of predefined data storage parameters. The predefined data storage parameters may include such as, but not limited to, an erasure cycle value of total number of cells in the data storage device, a maximum endurance target value of the host device, endurance of total number of memory cells in the one or more blocks of multi-level cells to serve the host device, a maximum erasure cycle, a size of each of the one or more blocks of multi-level cells, average erasure cycle and a total data value written from the host device to the persistent memory of the data storage device before an occurrence of the failure of the power support component, and the like. Herein, creating the block of SLC 314 may involve determining number of blocks to be extracted from the one or more MLC 316 and extracting the determined number of blocks from the one or more blocks of MLC 316 for creating the block of SLC 314.

Upon creating the block of SLC 314, the controller 308 may store the data received from the host device 304 via the non-persistent memory 310 in the block of SLC 314 of the persistent memory 312. In an embodiment, the controller 308 may transfer the data from the block of SLC 314 to the one or more blocks of MLC 316 based on predefined SLC parameters. In an embodiment, the predefined SLC parameters may include, but not be limited to, data capacity of the block of SLC 314, design of the block of SLC 314, and a halt state of the block of SLC 314.

Thus, the disclosure provides the block of SLC 314 for storing data received from the host device 304. As the block of SLC 314 is capable of storing a single bit of information per memory cell, even though the non-persistent memory 310 receives less number of data bits from the host device 304, the non-persistent memory 310 may send the less number of data bits received from the host device 304 to the persistent memory 312. Thus, use of dummy data in the persistent memory 312 may be avoided or a smaller number of dummy data may be used resulting in avoiding wastage of storage capacity of the memory cells of the persistent memory 312. Since requirement of dummy data in the persistent memory 312 is reduced additional time required for processing the dummy data in the blocks of multi-level cells 316 can be reduced. This leads to improving performance of the data storage device 302 while processing and storing the data in the data storage device 302 during power support component failure mode.

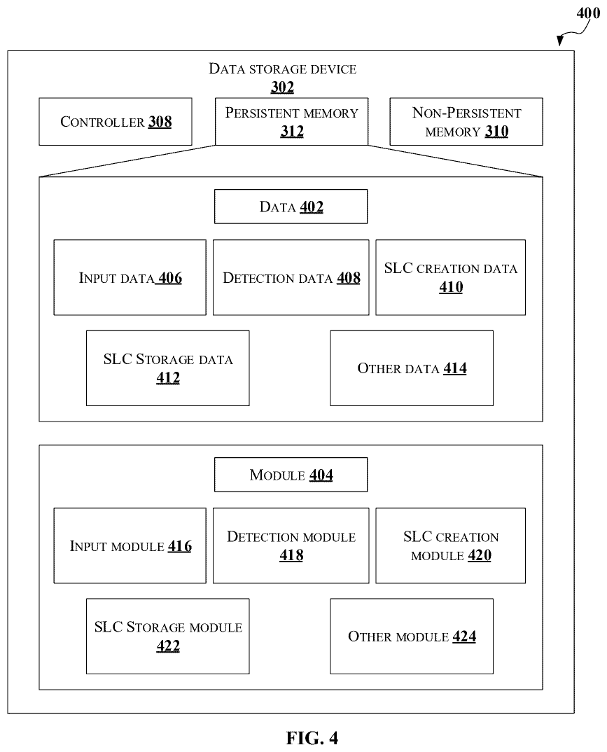

FIG. 4 illustrates a detailed diagram 400 of the data storage device 302 for writing data in a power support component failure mode, in accordance with an example embodiment of the disclosure. The data storage device 302 may include the controller 308 (also referred as “Central Processing Units”, “CPUs”, and “processor”), the persistent memory 312 and the non-persistent memory 310.

In an example embodiment, the persistent memory 312 and the non-persistent memory 310 may be communicatively coupled to the controller 308. The controller 308 may include at least one data processor for executing program components for executing user or system-generated requests. A memory may be communicatively coupled to the controller 308. A memory stores instructions, executable by the controller 308, which, on execution, may cause the controller 308 to write data in the power support component failure mode. In an example embodiment, the persistent memory 312 may include one or more modules 404 and data 402. According to an example embodiment of the disclosure, the one or more modules 404 may be configured to perform the operations for writing the data in the power support component failure mode. For example, the one or more modules 404 may be configured to use the data 402 and perform the operations for writing the data in the power support component failure mode. In an example embodiment, each of the one or more modules 404 may be a hardware which may be outside the persistent memory 312 and coupled with the data storage device 302. As used herein, the term modules 404 may include, but is not limited to, an Application Specific Integrated Circuit (ASIC), an electronic circuit, a Field-Programmable Gate Arrays (FPGA), Programmable System-on-Chip (PSoC), a combinational logic circuit, and/or other suitable components that provide described functionality.

According to an example embodiment, one or more of the modules 404 may be implemented by software or a combination of hardware and software. According to an example embodiment, the one or more modules 404 when configured with the described functionality defined in the disclosure will result in a novel hardware or may be considered as a special purpose processor. However, the disclosure is not limited thereto, and as such, the disclosure may be implemented in another way according to various other example embodiments. In an embodiment, an I/O interface is coupled with the controller 308 through which an input signal or/and an output signal is communicated. For example, the data storage device 302 may receive the data from the host device 304 via the I/O interface. The I/O interface may include an internal interface or an external interface.

According to an example embodiment, the modules 404 may include, for example, an input module 416, a detection module 418, a SLC creation module 420, a SLC module 422, and other modules 424. Such aforementioned modules 404 may be represented as a single module or a combination of different modules. In one implementation, the data 402 may include, for example, input data 406, detection data 408, SLC creation data 410, SLC data 412, and other data 414.

In an example embodiment, the input module 416 may be configured to receive the data from the host device 304 for storing the data in the data storage device 302. In an embodiment, the input module 416 may be present in the persistent memory 312 of the data storage device 302. The data received from the host device 304 may be stored as the input data 406 in the persistent memory 312. The data may be associated with any operations performed by the host device 304.

In an example embodiment, the detection module 418 may be configured to detect the failure in the power support component of the data storage device 302. The failure in the power support component may be detected using hardware components such as, the register, the interrupters, and the like. In an embodiment, the failure may be detected while the data is received from the host device 304 to be stored in the data storage device 302. In another embodiment, the failure may be detected while sending the data from the non-persistent memory 310 to the persistent memory 312. In another embodiment, the failure may be detected while the data is received from the host device 304 to the non-persistent memory 310. The detection of failure in the power support component may be stored as the detection data 408 in the persistent memory 312.

In an example embodiment, the SLC creation module 420 may be configured to create the block of SLC 314 in the persistent memory 312 of the data storage device 302. Upon detecting the failure in the power support component of the data storage device, the controller 308 may create the block of SLC 314 from the one or more blocks of the MLC 316 in the persistent memory 312 of the data storage device 302. The blocks of the SLC 314 may be created based on the values of predefined data storage parameters. The predefined data storage parameters may include such as, the erasure cycle value of total number of cells in the data storage device 302, the maximum endurance target value of the host device 304, endurance of total number of memory cells in the one or more blocks of multi-level cells 316 to serve the host device 304, the maximum erasure cycle, the size of each of the one or more blocks of multi-level cells 316, the average erasure cycle and the total data value written from the host device 304 to the persistent memory 312 of the data storage device 302 before an occurrence of the failure of the power support component.

In an embodiment, the erasure cycle value of the total number of cells in the data storage device 302 may refer to a sequence of events where the data written to the data storage device 302 may be erased and rewritten.

In an embodiment, the maximum endurance target value of the host device 304 refers to the maximum number of data bits that may be written from the host device 304 to the data storage device 302.

In an embodiment, endurance of total number of memory cells in the one or more blocks of multi-level cells 316 to serve the host device 304 may refer to the total number memory cells in the one or more blocks of multi-level cells 316 that may be required for storing the data served from the host device 304.

In an embodiment, the maximum erasure cycle may refer to the maximum number of erasure cycles that may be performed on the data storage device 302.

In an embodiment, the size of each of the one or more blocks of multi-level cells 316 may refer to the data capacity of each of the blocks in the one or more MLC 316. In another embodiment, the size of each of the one or more blocks of multi-level cells 316 may refer to the total number of memory cells in the one or more blocks of multi-level cells 316.

In an embodiment, the average erasure cycle may refer to the average number of erasure cycles that may be performed on the data storage device 302.

In an embodiment, the total data value written from the host device 304 to the persistent memory 312 of the data storage device 302 before an occurrence of the failure of the power support component may refer to the total number data bits written from the host device 304 to the persistent memory 312 of the data storage device 302 before the detection of failure in the power support component.

In an embodiment, the SLC creation module 420 may create the block of SLC 314 by determining the number of blocks to be extracted from the one or more blocks of multi-level cells 316 for creating the block of SLC 314. The number of blocks for creating the block of SLC 314 may be extracted based on endurance of total number of memory cells in the one or more blocks of multi-level cells 316. Then, the SLC creation module 420 may extract the determined number of blocks from the one or more blocks of multi-level cells 316. The block of SLC 314 may be created from the extracted number of blocks from the one or more multi-level cells 316.

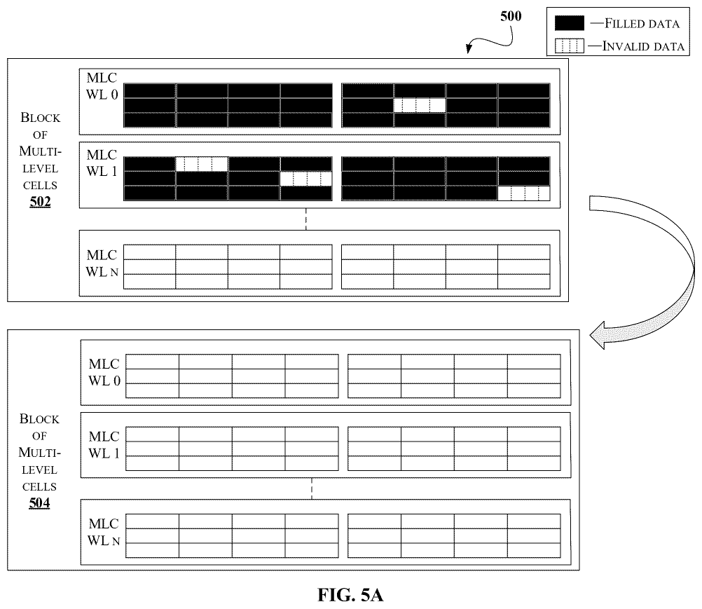

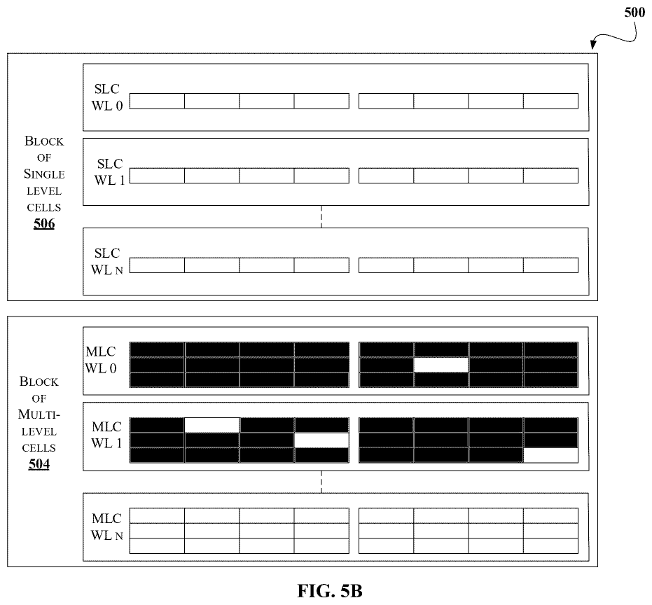

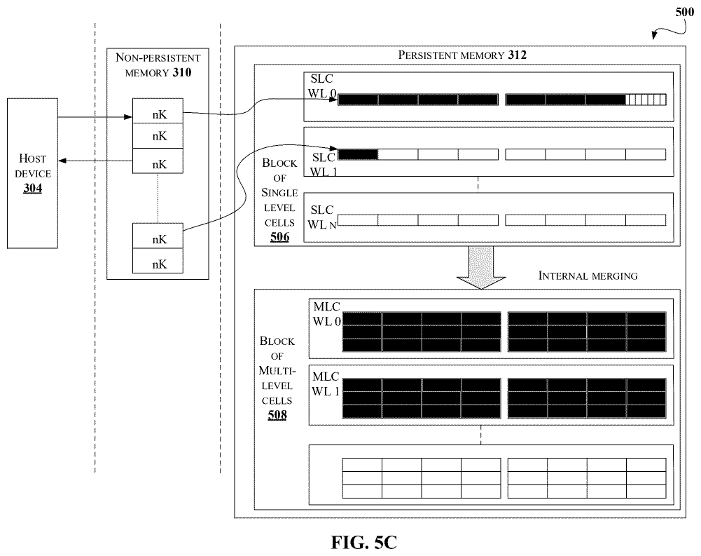

For instance, referring to FIG. 5A, a block of multi-level cells 502 may be filled with data received from the host device 304. The block of multi-level cells 502 may include one or more groups of memory cells (MLC WL0, MLC WL1, . . . , MLC WL N). Each of the groups of memory cells (MLC WL0, MLC WL1, . . . , MLC WL N) may include multiple memory cells. In a normal mode while power may be supplied to the data storage device 302 for storing data, the data received from the host device 304 is stored in the one or more blocks of the multi-level cells 502. In an embodiment, while creating a block of SLC 506 (shown in FIG. 5B), the data filled in the blocks of multi-level cells 502 may be transferred to another blocks of multi-level cells 504. The one or more blocks of multi-level cells 502 may be filled with both valid data received from the host device 304 along with invalid data. While creating the block of SLC 506, only the valid data may be transferred from the one or more blocks of multi-level cells 502 to the one or more blocks of multi-level cells 504. Thus, the one or more blocks of multi-level cells 502 may be erased upon transferring the data to the one or more blocks of multi-level cells 504.

Referring to FIG. 5B, the one or more blocks of multi-level cells 504 filled with only the valid data received from the one or more blocks of multi-level cells 502 is shown. A block of SLC 506 may be created from the one or more blocks of multi-level cells 502.

Referring to FIG. 5C, upon detecting a failure in the power support component, the non-persistent memory 310 transfers the data received from the host device 304 to the block of SLC 506 in the persistent memory 312. For instance, consider the data capacity of group of memory cells SLC WL0 of the block of SLC 506 may be 8 bits. In such case, when the host device 304 provides 7 bits of data, the non-persistent memory 310 transfers the 7 bits of data to the persistent memory 312. In the persistent memory 312 along with the 7 bits of data received from the host device 304, only one bit of dummy data may be added to fill the group of memory cells SLC WL0 and process the group of memory cells SLC WL0. Therefore, in the disclosure, only one bit of data capacity of the group of memory cells SLC WL0 in the block of SLC 506 may be wasted. Thus, use of dummy data in the persistent memory 312 may be avoided or a smaller number of dummy data may be used resulting in elimination of wastage of the storage capacity of the memory cells of the persistent memory 312. The dummy data filled in the persistent memory 312 is reduced thus leading to efficient performance of the data storage device 302, As a result, the time consumed for processing the dummy data in the blocks of multi-level cells 316 can be avoided. Thus, in the FUA mode while processing the multi-level cells, along with the memory cells filled with the data, the memory cells with the dummy data are also processed. Hence, the processing speed of the number of data bits filled in the block of SLC 314 along with the dummy data may be increased, as the number of dummy data used is reduced. This leads to an increase in the performance of the data storage device. Also, time consumed for processing a smaller number of data bits which is not equivalent to the total capacity of the groups of memory cells can be reduced.

Referring back to FIG. 4, in an embodiment, the number of blocks to be extracted from the one or more blocks of multi-level cells 316 may be extracted by determining a count of the block of SLC 314. The count of the block of SLC 314 may refer to the number of blocks to be extracted from the block of MLC 316.

In an example embodiment, the SLC creation module 420 may determine the count of the block of SLC 314 based on a function of total number of memory blocks in the data storage device 302 and a predetermined number of the one or more blocks of multi-level cells required in the data storage device 302 as shown in equation (1):

The count of the block of SLC=Total number of memory blocks in the data storage device minus (−) the predetermined number of the one or more blocks of multi-level cells required in the data storage device (1).

The predetermined number of the one or more blocks of multi-level cells required in the data storage device 302 is represented by equation (2) below:

The predetermined number of the one or more blocks of multi-level cells required in the data storage device=The remaining write capacity of the one or more blocks of the multi-level cells*the WAF/(the remaining erasure cycle*the size of the one or more blocks of the multi-level cells) (2).

Here, the ‘WAF’ may refer to the number of data bits written to the data storage device 302 with respect to the number of data bits received from the host device 304.

The remaining write capacity of the one or more blocks of the MLC 316 may refer to the total number of the group of memory cells that are left empty without filing with data. The remaining write capacity of the one or more blocks of the MLC 316 may be a function of the total capacity of the one or more blocks of the MLC 316 and the total bits of the data stored in the data storage device 302 before the detection of the failure in the power support component as shown in equation (3) below:

The remaining write capacity of the one or more blocks of the multi-level cells=total capacity of the one or more blocks of the multi-level cells−total bits of the data stored in the data storage device before the detection of the failure in the power support component (3).

Here, the total capacity of the one or more blocks of the MLC 316 may refer to the number of data bits the block of MLC 316 may store. The total bits of the data stored in the data storage device 302 before the detection of the failure in the power support component may refer to the number data bits filled in the block of MLC 316, before the detection of the failure in the power support component.

The remaining erasure cycle may refer to the number of erasure cycles that are left when the average erasure cycle for current time is eliminated from the maximum erasure cycle of the data storage device 302. The remaining erasure cycle may be a function of the maximum erasure cycle and the current average cycle as shown in equation (4) below:

The remaining erasure cycle=Maximum erasure cycle−current average erasure cycle (4).

In an example embodiment, the SLC module 422 may be configured to store the data in the block of SLC 314. The SLC module 422 may store the data received from the non-persistent memory 310 to the block of SLC 314 created in the persistent memory 312 of the data storage device 302.

In an embodiment, the data may be transferred/migrated from the block of SLC 314 to the one or more blocks of the multi-level cells 316 based on predefined SLC parameters upon storing the data to the block of SLC 314. Referring back to FIG. 5C, storing of the data received from the host device 304 in the block of SLC 506 in the persistent memory 312 is shown. In an embodiment, the block of SLC 506 may be merged/migrated with a block of multi-level cells 508 for transferring the data from the block of SLC 506 to a block of multi-level cells 508 based on the predefined SLC parameters. Therefore, the disclosure may ensure continuous availability of the block of SLC 506 for storing the data received from the host device 304 in the power support component failure mode.

In an embodiment, the predefined SLC parameters may include, but are not limited to, the data capacity of the block of SLC 506, the design of the block of SLC 506 and the halt state of the block of SLC 506. For the data capacity of the block of SLC 506, consider the total bit capacity of the groups of memory cells (WL 0, WL 1, . . . , WL N) of the block of SLC 506 is reached. Then, the data from the block of SLC 506 may be transferred to the block of MLC 508. For the halt state of the block of SLC 506, consider that the block of SLC 506 may enter to the halt state as that the non-persistent memory 310 may not transfer the data to the block of SLC 506 for 2 ms. Then, the block of SLC 506 may transfer the data to the block of MLC 508. For the design of the block of SLC 506, the block of SLC 506 may be designed to transfer the data to the block of MLC 508 for each 5 ms or 10 ms, and the like.

The other data 414 may store data, including temporary data and temporary files, generated by the one or more modules 404 for performing the various functions of the data storage device 302. The one or more modules 404 may also include the other modules 424 to perform various miscellaneous functionalities of the data storage device 302. The other data 414 may be stored in the persistent memory 312. It will be appreciated that the one or more modules 404 may be represented as a single module or a combination of different modules.

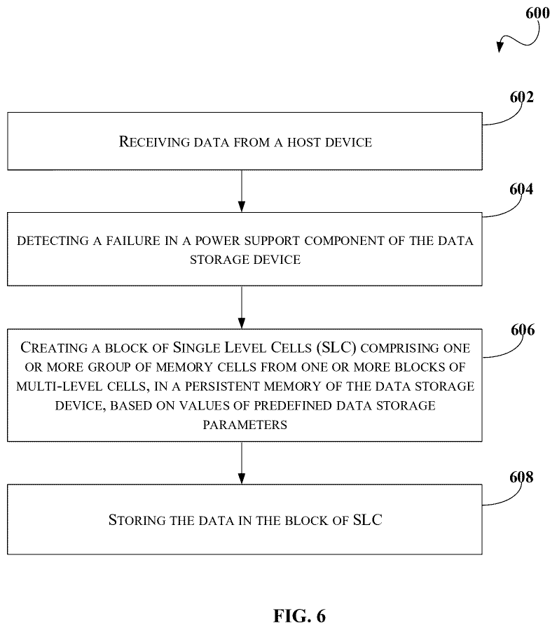

FIG. 6 shows a flow chart illustrating method operations for writing data in power support component failure mode, in accordance with an example embodiment of the disclosure. As illustrated in FIG. 6, the method 600 may include one or more operations. The method 600 may be described in the general context of computer executable instructions that may include routines, programs, objects, components, data structures, procedures, modules, and functions, which perform particular functions or implement particular abstract data types.

The order in which the method 600 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At operation 602, the controller 308 may be configured to detect the failure in the power support component of the data storage device 302 while storing data received from the host device 304 to the data storage device. The controller 308 may detect the failure using hardware components such as register, interrupter, and the like.

At operation 604, the controller 308 may be configured to create the blocks of SLC 314 upon detecting the failure in the power support component. The blocks of SLC 314 are created from the one or more blocks of multi-level cells 316 in the persistent memory 312 of the data storage device 302 based on the values of the predefined data storage parameters. The block of SLC 314 may be created by determining the number of blocks to be extracted from the one or more blocks of multi-level cells 316. Then, the controller 308 may extract the determined number of blocks from the one or more blocks of the multi-level cells 316 to create the block of SLC 314.

At operation 606, the controller 308 may be configured to store the data in the block of SLC 314. Upon creating the block of the SLC 314, the controller may store the data received from the host device 304 in the block of SLC 314 of the persistent memory 312 in the data storage device 302. The controller 308 may transfer the data from the block of SLC 314 to the one or more blocks of the MLC 316 based on predefined SLC parameters. In an embodiment, the predefined SLC parameters may refer to data capacity of the block of SLC 314, design of the block of SLC 314 and a halt state of the block of SLC 314.

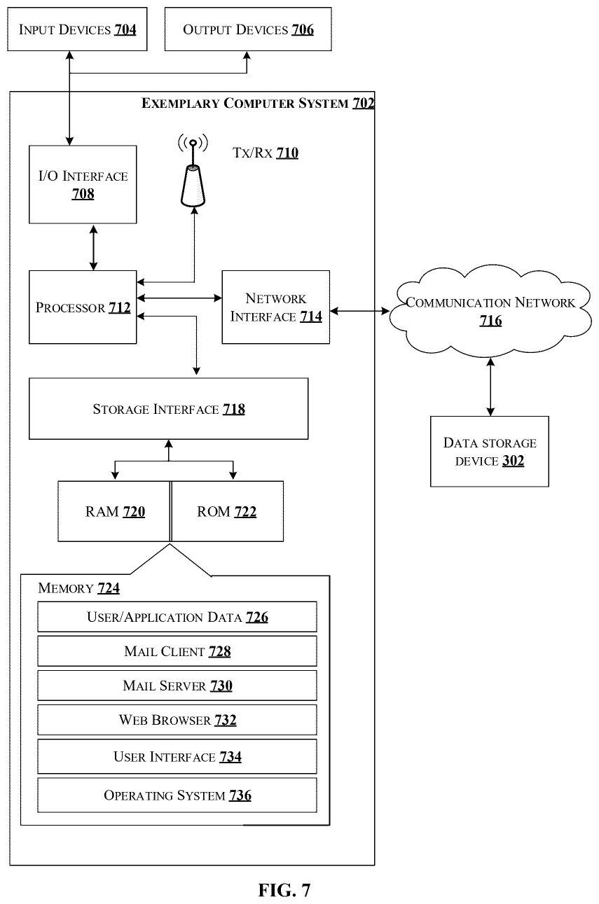

FIG. 7 illustrates a block diagram of a computer system 700 for implementing example embodiments consistent with the disclosure. In an example embodiment, the computer system 700 may include the data storage device 302. Thus, the computer system 702 may be used for writing data in power support component failure mode. The computer system 702 and the data storage device 302 may be connected via an interface. The interface may include an internal interface or an external interface. The computer system 702 may include a central processing unit 712 (also referred as “CPU”, “processor 712” or a controller). The processor 712 may include at least one data processor (one or more data processors). The processor 712 may include specialized processing units such as integrated system (bus) controllers, memory management control units, floating point units, graphics processing units, digital signal processing units, etc.

The processor 712 may be configured to communicate with one or more input/output (I/O) devices via I/O interface 708. The I/O interface 708 may employ communication protocols/methods such as, without limitation, audio, analog, digital, monoaural, RCA, stereo, Institute of Electrical and Electronics Engineers (IEEE)-1394, serial bus, universal serial bus (USB), infrared, PS/2, BNC, coaxial, component, composite, digital visual interface (DVI), high-definition multimedia interface (HDMI), radio frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 708, the computer system 702 may communicate with one or more I/O devices. For example, the input device 704 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 706 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor 712 may be configured to communicate with the communication network 716 via a network interface 714. The network interface 714 may communicate with the communication network 716. The computer system 702 may communicate with the data storage device 302 via the communication network 716. The network interface 714 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 716 may include, without limitation, a direct interconnection, local area network (LAN), wide area network (WAN), wireless network (e.g., using Wireless Application Protocol), the Internet, etc. The network interface 714 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 716 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In an example embodiment, the processor 712 may be configured to communicate with a memory 724 (e.g., RAM, ROM, etc.) via a storage interface 718. The storage interface 718 may connect to memory 724 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 724 may store a collection of program or database components, including, without limitation, user interface 734, an operating system 736, web browser 732 etc. In an example embodiment, computer system 702 may store user/application data, such as, the data, variables, records, etc., as described in this disclosure. Such databases may be implemented as fault-tolerant, relational, scalable, secure databases such as Oracle® or Sybase®.

The operating system 736 may facilitate resource management and operation of the computer system 500. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLER ANDROID™, BLACKBERRY® OS, or the like.

In an example embodiment, the computer system 702 may implement the web browser 732 stored program component. The web browser 732 may be a hypertext viewing application, for example MICROSOFT® INTERNET EXPLORER™, GOOGLER CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 732 may utilize facilities such as AJAX™, DHTML™, ADOBE® FLASH™, JAVASCRIPT™, JAVA™, Application Programming Interfaces (APIs), etc. In an example embodiment, the computer system 702 may implement a mail server stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In an example embodiment, the computer system 702 may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform operations or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

According to an example embodiment, there is provided a method and a data storage device for writing data in power support component failure mode. In the disclosure, the data storage device creates the block of SLC from blocks of multi-level cells in the persistent memory. The block of SLC is created based on predefined data storage parameters. Upon creation of the block of SLC, the data received from the host device is stored in the block of SLC. Thus, use of dummy data in the persistent memory 312 may be avoided or a smaller number of dummy data may be used resulting in avoiding wastage of storage capacity of the memory cells of the persistent memory 312. Since the requirement of dummy data in the persistent memory is reduced, additional time required for processing the dummy data in the blocks of multi-level cells can be reduced. This leads to improving performance of the data storage device 302 while processing and storing the data in the data storage device during power support component failure mode.

In the above example embodiments, components according to example embodiments of the disclosure are referenced by using modules or units. The modules or units may be implemented with various hardware devices, such as an integrated circuit, an application specific integrated circuit (ASIC), a field programmable gate array (FPGA), and a complex programmable logic device (CPLD), firmware driven in hardware devices, software such as an application, or a combination of a hardware device and software. Also, the modules or units may include circuits implemented with semiconductor elements in an integrated circuit, or circuits enrolled as an intellectual property (IP).

The illustrated operations of FIG. 6 show certain events occurring in a certain order. In alternative embodiments, certain operations may be performed in a different order, modified, or removed. Moreover, operations may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the disclosure are intended to be illustrative, but not limiting, of the scope of the disclosure, which is set forth in the following claims.

While multiple aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method performed by a data storage device, the method comprising:
receiving, by a controller of the data storage device, a data from a host device;
detecting, by the controller of the data storage device, a failure in a power support component of the data storage device;
creating, by the controller, a block of single level cells (SLC) comprising one or more groups of memory cells from one or more blocks of multi-level cells, in a persistent memory of the data storage device, based on values of predefined data storage parameters; and
storing, by the controller, the data in the block of SLC.

2. The method of claim 1, wherein the predefined data storage parameters comprise:
an erasure cycle value of a total number of cells in the data storage device,
a maximum endurance target value of the host device,
endurance of total number of memory cells in the one or more blocks of multi-level cells to serve the host device,
a maximum erasure cycle,
a size of each of the one or more blocks of multi-level cells,
an average erasure cycle, and
a total data value written from the host device to the persistent memory of the data storage device before an occurrence of the failure of the power support component.

3. The method of claim 1, wherein the creating, by the controller, the block of SLC comprises:
determining, by the controller, a number of blocks to be extracted from the one or more blocks of multi-level cells for creating the block of SLC based on endurance of a total number of memory cells in the one or more blocks of multi-level cells;
extracting, by the controller, the determined number of blocks from the one or more blocks of multi-level cells; and
creating, by the controller, the block of SLC from the extracted one or more blocks of multi-level cells.

4. The method of claim 1, wherein the creating, by the controller, the block of SLC further comprises determining a count of the block of SLC based on a function of a total number of memory blocks in the data storage device and a predetermined number of the one or more blocks of multi-level cells required in the data storage device.

5. The method of claim 4, wherein the predetermined number of the one or more blocks of multi-level cells required in the data storage device is determined based on at least one of:
remaining write capacity of the one or more blocks of multi-level cells,
a Write Amplification Factor (WAF) corresponding to the respective one or more blocks of multi-level cells,
a remaining erasure cycle, and
a size of the one or more blocks of multi-level cells.

6. The method of claim 1, further comprising transferring the data from the block of SLC to the one or more blocks of multi-level cells based on predefined SLC parameters.

7. The method of claim 6, wherein the predefined SLC parameters comprise data capacity of the block of SLC, design of the block of SLC, and a halt state of the block of SLC.

8. A data storage device comprises:
a persistent memory;
a non-persistent memory; and
a controller configured to:
receive a data from a host device,
detect a failure in a power support component of the data storage device,
create a block of Single Level Cells (SLC) comprising one or more group of memory cells from one or more blocks of multi-level cells, in the persistent memory of the data storage device, based on values of predefined data storage parameters, and
store the data in the block of SLC.

9. The data storage device of claim 8, wherein the predefined data storage parameters comprise:
an erasure cycle value of total number of cells in the data storage device,
a maximum endurance target value of the host device,
endurance of total number of memory cells in the one or more blocks of multi-level cells to serve the host device,
a maximum erasure cycle,
a size of each of the one or more blocks of multi-level cells,
an average erasure cycle, and
a total data value written from the host device to the persistent memory before an occurrence of the failure of the power support component.

10. The data storage device of claim 8, wherein the controller is further configured to create the block of SLC by:
determining a number of blocks to be extracted from the one or more blocks of multi-level cells for creating the block of SLC based on endurance of a total number of memory cells in the one or more blocks of multi-level cells,
extracting the determined number of blocks from the one or more blocks of multi-level cells, and
creating the block of SLC from the extracted one or more blocks of multi-level cells.

11. The data storage device of claim 8, wherein the controller is further configured to create the block of SLC by determining a count of the block of SLC based on at least one of a total number of memory blocks in the data storage device and a predetermined number of the one or more blocks of multi-level cells required in the data storage device.

12. The data storage device of claim 11, wherein the controller is further configured to determine a number of the one or more blocks of multi-level cells required in the data storage device based on at least one of:
remaining write capacity of the one or more blocks of multi-level cells,
a Write Amplification Factor (WAF) corresponding to the respective one or more blocks of multi-level cells,
a remaining erasure cycle, and
a size of the one or more blocks of multi-level cells.

13. The data storage device of claim 8, wherein the controller is further configured to transfer the data from the block of SLC to the one or more blocks of multi-level cells based on predefined SLC parameters.

14. The data storage device of claim 13, wherein the predefined SLC parameters comprise data capacity of the block of SLC, a design of the block of SLC, and a halt state of the block of SLC.
